(19) United States
(12) Patent Application Publication
(10) Pub. No.: US 2020/0329691 A1
(43) Pub. Date: Oct. 22, 2020

(54) Heated and/or Cooled Rodent Trap

(71) Applicant: Charlene F. Chessum, Stockton, CA (US)

(72) Inventor: Charlene F. Chessum, Stockton, CA (US)

(21) Appl. No.: 16/286,512

(22) Filed: Feb. 26, 2019

Related U.S. Application Data
(60) Provisional application No. 62/710,731, filed on Feb. 26, 2018.

(51) Int. Cl. A01M 23/00

(52) U.S. Cl. CPC A01M 23/00

(57) ABSTRACT

The present invention relates generally to rodent traps that use food and/or poison to entice the rodent to the trap. This invention uses heat and/or cool air to entice the rodent to the trap. During the cool weather season heat is used to entice the rodent. During the warm weather season cooling is used to entice the rodent. This method can be used for non-kill type rodent traps or kill type rodent traps. This device can also be used to catch other pests such as snakes, squirrels, foxes—whatever animal, pest or rodent is attracted to temperatures to warm up or cool down.

This application claims a priority of provisional application No. 62/710,731.

### BACKGROUND

Rodent Traps of various designs have been used by a person to capture rodents of various sizes. Existing rodent traps capture rodents by containing them and releasing them or by killing them with a contraption or a poison then disposing them. The rodents are enticed to the trap with some sort of food source. Rodent traps are made out of various durable materials.

Rodent traps have become more humane over the years, but they still entice rodents in the same manner. Rodent traps clap down on the rodent killing them, use a pool of water when they fall in and drown, electrocute them where they die, use a sticky surface so the rodent gets stuck to the paper or use a trap door where they can go in but can't get out. The trap door methods allows the user to dispose the rodents in a humane manner or kill them.

There are rodent traps that have alerts letting you know you have a catch. Some have a clear lid so you can look inside to see if there is anything in the trap.

The problem is that rodent traps really haven't evolved and change the way they entice rodents to the trap.

### SUMMARY

This invention relates to a rodent trap that entices rodents with temperature changes. This invention uses a heat source when it is in an area where there are colder temperatures and a cooling source when it is in an area where there are warmer temperatures. The change in temperature will entice the rodents to the trap. Food and/or can be added as well for additional incentive. Poison can be added as well, if the user would prefer to kill the rodents.

When the seasons change is when you see an influx of rodents in areas they are not wanted. The rodents are looking for a way to stay warm in the colder areas and to cool off in the warmer areas.

### DESCRIPTION OF DRAWINGS

FIG. 1 shows a multi-catch rodent trap that has a spring loaded trap door at the entrance. Item 1 shows a heat lamp bulb, such as ceramic heat emitting bulb or infrared basking bulb, that can be used for additional heat when necessary. 2 shows the latches that allows an individual to open the rodent trap to release the catch or dispose of the catch. 3 shows the entrance to the spring loaded trap door. The trap door allows rodents in, but does not allow them to exit the trap. 4 shows air vents that allows air in the trap for use when using as a catch and release trap. 5 shows the bottom of the trap where heating and cooling coils are housed.

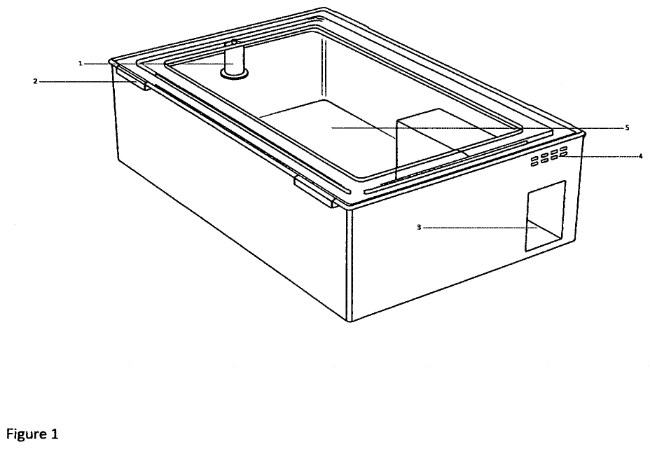

FIG. 2 shows a traditional snap rodent trap that has a spring loaded mechanism that snaps down on the rodent killing them. Item 1 is the snapping mechanism. 2 shows where the bait is placed. 3 shows the bottom of the trap where the heating and cooling

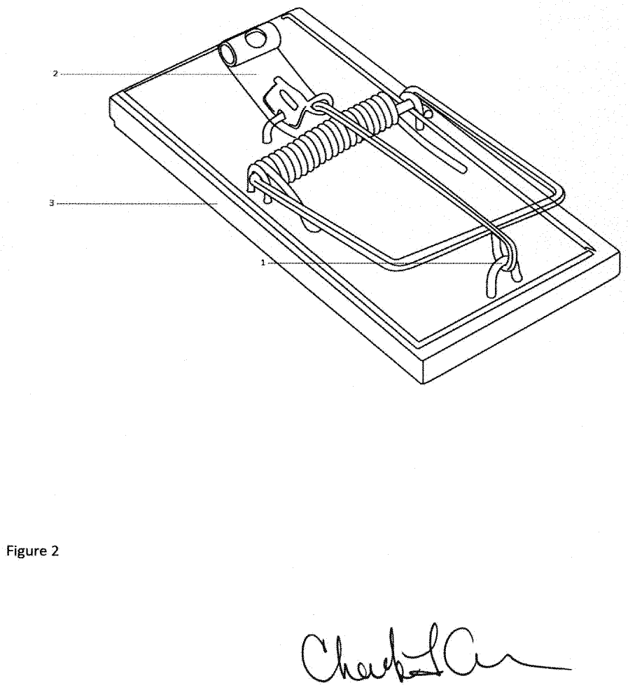

### DESCRIPTION OF THE INVENTION

This invention allows the user to attract rodents to the trap using hot and cold air. When it's cold in the area a heat source will be used. When it's hot in the area a cold source will be used.

1. A rodent trap apparatus containing a heating element or apparatus that attracts the rodents to the trap.

2. A rodent Trap apparatus containing a cooling element or apparatus that attracts the rodent to the trap.
